(19) United States
(12) Patent Application Publication
(10) Pub. No.: US 2023/0256797 A1
(43) Pub. Date: Aug. 17, 2023

(54) Roof assembly and motor vehicle comprising such a roof assembly

(71) Applicant: Webasto SE, Stockdorf (DE)

(72) Inventors: Magnus SVIBERG, Stockdorf (DE); Maximilian EHRMANN, Stockdorf (DE); Cèdric LANGLAIS, Stockdorf (DE); Michael HUELSEN, Stockdorf (DE)

(21) Appl. No.: 18/166,729

(22) Filed: Feb. 9, 2023

(30) Foreign Application Priority Data
Feb. 15, 2022 (DE) 10 2022 103 526.3

(51) Int. Cl. B60J 7/043

(52) U.S. Cl. CPC B60J 7/043

(57) ABSTRACT

A roof assembly having a roof skin having at least one roof opening; at least one roof panel element configured to selectively open or close the roof opening and/or forming a fixed roof element having an at least partially transparent see-through area and filling the roof opening; and a roof headliner disposed below and spaced apart from the roof skin, thus limiting an installation space together with the roof skin, and having a cover element covering at least part of an edge area around the roof opening inside the vehicle. At least one functional feature is disposed on the cover element.

### CROSS-REFERENCE TO RELATED APPLICATION

This application claims priority from German Patent Application Number DE 10 2022 103 526.3, filed Feb. 15, 2022, which is hereby incorporated herein by reference in its entirety for all purposes.

### FIELD

The invention relates to a roof assembly, in particular for a passenger car, according to the preamble of claim 1. Furthermore, the invention relates to a motor vehicle comprising such a roof assembly.

### BACKGROUND

Generic roof assemblies and motor vehicles comprising such roof assemblies are known from the state of the art. A generic roof assembly, in particular one configured as a roof module forming a vehicle roof of the motor vehicle, can be pre-fabricated as a separate functional module, for example, and can be provided directly at the assembly line for the purpose of installation. At its outer surface, the roof assembly at least partially forms a roof skin of the vehicle roof, which prevents humidity and air flows from entering the vehicle interior. For example, the roof skin is formed by one or more panel components, which can be made of a stable material, such as painted metal or painted or died-through plastic, and/or glass. Likewise, roof assemblies are known whose roof skin comprises a roof opening which can be selectively opened and/or closed by a roof panel element and/or which can be filled with the roof panel element, which forms a fixed roof element and which has an at least partially transparent see-through area.

Furthermore, the development in vehicle manufacturing is increasingly focusing on autonomously and semi-autonomously driving motor vehicles. In order to enable the vehicle controller to control the motor vehicle autonomously or semi-autonomously, a plurality of electrical, electronic and/or electromagnetic components are required, which are installed throughout the motor vehicle. Components of this kind can be environment sensors (e.g., lidar sensors, radar sensors, cameras, multi cameras, etc. including other (electrical) components), for example, which are configured to detect the environment surrounding the motor vehicle and determine, for example, a current traffic situation from the acquired environment data. In this context, roof modules that comprise a plurality of environment sensors and/or other electrical, electronic and/or electromagnetic components in order to detect a vehicle environment as fully as possible are known from the state of the art. Roof modules of this kind are also referred to as roof sensor modules (RSM). The known environment sensors send and/or receive suitable electromagnetic signals, such as laser beams or radar beams, allowing a data model of the vehicle environment to be generated by suitable signal evaluation and to be used for controlling the vehicle.

Owing to increasing digitalization and networking, vehicle manufacturing is increasingly required to integrate more and more functional features, such as control elements and/or control panels and/or screens, in the vehicle interior so as to provide a driver and/or a passenger with information as clearly laid out and comprehensive as possible.

All of the components and/or functional features mentioned above and other components needed for the vehicle require the provision of suitable installation space, which is a scarce resource in the automotive field. Therefore, the complexity in packaging for a vehicle grows as mechanization and/or automation increase and poses ever growing challenges not only for designers, mechanics and/or service personnel.

### SUMMARY

Hence, the object of the invention is to propose a roof assembly that reduces the mentioned problems of the state of the art and in particular provides a use of space that is optimized in terms of installation space for the placement of functional features.

The object is attained by a roof assembly according to the teaching of claim 1. Furthermore, the object is attained by a motor vehicle according to claim 10, which comprises such a roof assembly.

Advantageous embodiments of the invention are the subject matter of the dependent claims. Moreover, any and all combinations of at least two features disclosed in the description, the claims, and/or the figures fall within the scope of the invention. Naturally, the explanations given in connection with the roof assembly equivalently relate to the motor vehicle according to the invention and without being mentioned separately in its context. In particular, linguistically common rephrasing and/or an analogous replacement of respective terms within the scope of common linguistic practice, in particular the use of synonyms backed by the generally recognized linguistic literature, are of course comprised by the content of the disclosure at hand without every variation having to be expressly mentioned.

The roof assembly according to the invention, in particular for a passenger car, has a roof skin, which comprises at least one roof opening, and at least one roof panel element, which is configured to selectively open or close the roof opening and/or forms a fixed roof element having an at least partially transparent see-through area and filling the roof opening. Furthermore, the roof assembly according to the invention has a roof headliner disposed below and spaced apart from the roof skin, preferably when viewed in a vertical direction, thus limiting an installation space together with the roof skin, and comprising a cover element covering at least part of an edge area around the roof opening inside the vehicle. The roof assembly according to the invention is characterized in that at least one functional feature is disposed on the cover element. So, according to the invention, the cover element can cover the edge area inside the vehicle either fully, in particular circumferentially around the edge area, or only in part.

So, according to the invention, a generally available installation space formed between the roof skin, which in particular faces a vehicle exterior, and the roof headliner is utilized for arranging at least one technical and/or electrical and/or electronic and/or electromagnetic functional feature in the area of the cover element. In this manner, the use of the installation space available in the roof area can be optimized compared to the state of the art since the areas of the roof headliner around the roof opening that serve as a cover or a screen are now also effectively used for arranging technical components. Thus, no additional installation space has to be made available in the roof area even in the event of further automation and/or mechanization. Without the arrangement according to the invention, additional installation space would have to be made available by making the passenger compartment smaller, for example. However, this has a negative impact on how the space feels to the passenger, which is to be avoided. The inventors have found at hand that the installation space in the area of the cover element, which preferably surrounds the roof opening, can be effectively used for arranging functional features, which preferably allow user interaction. The installation space available in the area of the cover element is in particular a result of the fact that there is a gap and/or a step and/or a shoulder between the roof headliner and the surface of the roof panel facing the vehicle interior because of the distance between the roof headliner and the roof skin, which has to be covered by means of the cover element in order to satisfy the aesthetic aspects inside the passenger compartment.

The roof headliner preferably serves as a lining and/or a cover and/or a screen for the passenger compartment from the roof skin and/or a roof frame structure of the vehicle body with the result that the roof components of the vehicle carcass and/or other technical components cannot be seen from the passenger compartment. The roof headliner can preferably be made of a plastic and/or a metallic material. The at least one roof opening is provided in the roof skin.

The roof opening can basically be of any size. In the case of a continuous panoramic roof, for example, the roof opening can be limited by the transverse and side rails of the vehicle body with the result that the roof skin merely covers the transverse and side rails, e.g., with a panel component, whereas the roof opening is filled by the panoramic roof in this case. Also, only part of the roof skin may comprise the roof opening while the remaining roof skin is formed by at least one panel component. The at least one roof panel element can preferably be provided with a roof opening system in the area of the roof opening, such as a sunroof or a folding roof or a removable fixed roof element, by means of which the roof opening can be opened or closed at will. Alternatively or additionally, the roof opening can also be filled by a fixed roof element forming the roof panel element. The fixed roof element can preferably be transparent or semi-transparent so that ambient light and/or daylight can enter a vehicle interior. The roof skin is preferably formed by at least one panel component and the at least one roof panel element so that the entire roof area can be closed from a vehicle exterior in a moisture-proof manner or is closed in the case of a fixed roof element. So, according to the invention, the roof skin is preferably formed by multiple parts and preferably comprises at least one panel component, which is preferably made of opaque metal and/or opaque plastic, and the at least one roof panel element, which is in particular transparent or semi-transparent. So the roof skin or the vehicle roof according to the invention is preferably partially transparent and partially non-transparent.

The expression “at least one” as used herein means that the roof assembly according to the invention can comprise one or more than one such component. Moreover, it is noted that the expression “at least one electrical, electronic and/or electromagnetic component” as used in this description is used equivalently to the shortened expression “at least one component”. Of course, the roof assembly according to embodiments of the invention can have multiple electrical, electronic and/or electromagnetic functional features, which can in particular have different functions.

According to a preferred embodiment, the cover element is formed integrally with the roof headliner. So, particularly preferably, the cover element is formed integrally with the remaining roof headliner. So the roof headliner is preferably configured in such a manner in the edge area of the roof opening that it covers the edge area, in particular opaquely. The functional feature can preferably be glued and/or screwed and/or soldered and/or bolted to the cover element.

According to a preferred embodiment, the cover element forms at least one mounting surface on a surface opposite a vehicle interior, the mounting surface preferably extending along the edge area of the roof opening, preferably around the entire roof opening, and the at least one functional feature being disposed on the mounting surface. The mounting surface can preferably serve to attach and/or fix the functional feature on at least one side. Of course, the cover element can also comprise at least one opening in the direction of the passenger compartment through which the functional feature can be slid in order to be operable from the passenger compartment, for example. When the functional feature is disposed in such a manner, the mounting surface can be provided for the purpose of securing the functional feature against dropping out of the opening and thus fix it to the cover element, for example.

According to a preferred embodiment, the cover element forms a wall area of the installation space that is in particular essentially (i.e., in particular ±10%) vertical or wall area of the installation space that is in particular inclined relative to a vertical and/or a horizontal, the at least one functional feature being attached to said wall area. So the wall area can preferably be essentially vertical or inclined. For example, a slight inclination, in particular diverting from a vertical by ±10%, is possible. This can be advantageous if the functional feature is supposed to point into the vehicle interior at an angle since this is advantageous for functional reasons and/or design reasons, for example. The wall area preferably forms the mounting surface mentioned above. Of course, the cover element can also comprise an arced and/or bent and/or curved shape, in particular cross section, as a result of which a transition between the roof headliner and the inner surface of the roof panel element is preferably smooth. To this end, the cover element can have a curved shape with at least one predetermined curvature radius in cross section, for example.

According to a preferred embodiment, the at least one functional feature comprises at least one image display feature, in particular a display, and/or one audio playback feature, in particular a microphone, and/or one touch panel and/or one control element, such as a turning knob and/or a switch and/or a button, and/or one light feature, in particular an entrance light and/or a reading light and/or interior lighting and/or a light concept of a passenger compartment, and/or one feature for optical communication, in particular with a function alerting a passenger to at least one detected traffic situation, such as a red light, and/or one sensor-based detection feature. The sensor-based detection feature can be a camera for detecting the vehicle passengers, for example. The sensor-based detection feature can also be configured to detect a condition of a driver and/or a passenger regarding fatigue and/or a body temperature and/or a heart rate and/or a posture and to issue an alert in the event of a critical state (such as critical fatigue). Such an alert can alert the driver to their critical fatigue state and to the fact that the driver is likely to fall asleep, for example. The sensor-based detection feature can also be configured to track and/or detect at least one object within or outside of the passenger compartment in order to monitor it, for example. Of course, other functional features, which are not explicitly named here and which allow interaction with a passenger of the motor vehicle, can be disposed on the cover element. For example, the functional feature can also comprise a head heater, which heats a roof area around the roof opening to thus protect the passenger(s) from cold. This can improve a comfort of the driver in the long term, in particular in winter and/or at cold outside temperatures and if the roof panel is designed with a large surface area.

According to a preferred embodiment, the roof assembly defines a roof module for forming the vehicle roof, the roof module comprising at least one electrical and/or electronic and/or electromagnetic component, in particular an environment sensor, which is configured to send and/or receive electromagnetic signals in order to detect a vehicle environment and which is preferably disposed in the installation space limited by the roof skin and the roof headliner. A component of this kind can preferably be intended to enable the motor vehicle to drive autonomously or semi-autonomously and/or in a supervised manner. The at least one component is preferably configured to detect a vehicle environment.

According to a preferred embodiment, the at least one electrical and/or electronic and/or electromagnetic component comprises an antenna and/or a measuring sensor and/or a communication feature and/or a light feature and/or an environment sensor, in particular a lidar sensor and/or a radar sensor and/or a camera sensor and/or a multi-camera sensor and/or an ultrasonic sensor. Of course, the component can also comprise more than one of each of the mentioned components. The antenna can be an electrical or magnetic antenna. The measuring sensor can be a temperature sensor, a humidity sensor, a GPS sensor, an acceleration sensor and/or a similar measuring sensor, for example. The communication feature can be a WLAN interface, an LTE interface or another near-, medium- or long-range communication interface. The communication feature allows the motor vehicle to communicate with a vehicle environment and in particular to send and/or receive data. The light feature can comprise one or more than one light. The lights are in particular configured to indicate a (semi-)autonomous driving mode and/or different driving mode situations of the motor vehicle. The environment sensor according to the invention can basically be configured in various ways and can comprise a lidar sensor, a radar sensor, an optical sensor, such as a camera or a multi-camera, an ultrasonic sensor and/or the like. Lidar sensors, for example, operate in a wavelength range of 905 nm or approximately 1550 nm. A material in a see-through area of the environment sensor is preferably transparent to a wavelength range used by the environment sensor and selected as a function of the wavelength(s) used by the environment sensor. Of course, merely a signal detection unit, such as an optical sensor and/or a fotochip, may be disposed on the vehicle body. Evaluation electronics, in particular referred to as a camera control unit (CCU), which is configured to evaluate the signals detected by the optical sensor, can be disposed separately therefrom in another area of the motor vehicle, for example.

According to a preferred embodiment, the roof assembly configured as a roof module is disposed on a vehicle body of a motor vehicle as a structural unit. In this case, the roof module can preferably be disposed on the vehicle body by being connected to the at least one longitudinal rail or longitudinal beam of a vehicle roof frame, which is part of the vehicle body, preferably via a glued connection, a screwed connection and/or a welded connection. The roof module can preferably form a structural unit in which features for autonomous or semi-autonomous driving assisted by driver assistance systems are integrated and which can be placed and/or arranged on a vehicle carcass as a unit by a vehicle manufacturer. Furthermore, in one configuration of the roof panel element, the roof module according to the invention can form a purely fixed roof or a roof panel element including a roof opening system. Furthermore, the roof module according to the invention can be configured for use on a passenger car or on a utility vehicle.

According to a preferred embodiment, at least one cleaning feature and/or one temperature control feature (i.e., a cooling feature and/or a heating feature) and/or one control feature and/or one amplifying feature and/or one optical feature and/or one communication interface and/or one energy generation feature and/or one energy storage feature is disposed in the installation space limited by the roof skin and the roof headliner.

A preferred cleaning feature of this kind preferably comprises at least one cleaning nozzle for cleaning a see-through area through which the at least one component, in particular a measuring sensor and/or an environment sensor, looks, and/or at least one wiper for cleaning a see-through area through which the at least one component, in particular a measuring sensor and/or an environment sensor, looks, and/or one or more than one connecting line for supplying a cleaning fluid. The cleaning feature is preferably connected to a tank, which can be disposed anywhere in the motor vehicle. The cleaning fluid can be a liquid, a gas and/or pressurized air. The cleaning feature is configured to clean a see-through area through which the at least one component, in particular a measuring sensor and/or an environment sensor, looks. This supports or improves the function of the at least one component since the at least one component, which is in particular an environment sensor and/or a measuring sensor, can operate without interruption as dirt is effectively removed from the see-through area.

A temperature control feature of this kind preferably comprises at least one heat conduction channel or a cooling channel (see descriptions above) and/or at least one heat transfer element and/or at least one fan and/or at least one heat exchanger and/or at least one heat conduction pipe (also referred to as a heat pipe). The temperature control feature is configured to air-condition or control the temperature of the at least one component (i.e., to keep it at a predetermined (operating) temperature). For providing this additional temperature control function for the at least one component, the temperature control feature is preferably connected to the at least one component via at least one heat conduction interface when the roof module is disposed on the vehicle body. This provides a temperature control function of the at least one component, which ensures the reliability of the at least one component during operation and in particular prevents the at least one component from overheating. The temperature control feature preferably keeps the at least one component at a predetermined operating temperature.

A control feature of this kind can preferably control one or more than one function of the at least one component. In particular, the control feature can execute software that controls the function or multiple functions of the at least one component by means of a processor, for example. For example, the control feature can also receive software updates, e.g., via a communication interface of the motor vehicle (see also the explanations above), so that a range of functions of the at least one component can be extended by such a software update. The control feature can also extend a range of functions of the at least one component by providing extended control functions that cannot be executed by a controller of the component itself, for example. The control feature preferably allows extending a range of functions of the at least one component in the course of a retrofit.

An amplifying feature of this kind can preferably be configured to amplify a transmitting power and/or a receiving power of the at least one component and thus improve the performance of the at least one component. The amplifying feature can comprise a signal amplifier or the like, for example.

An optical device of this kind can comprise a see-through area in the form of a window and/or a lens and/or another type of optical element, for example. The optical feature is preferably configured to provide a see-through area for the at least one component, which is in particular an environment sensor and/or a measuring sensor, through which the at least one component can look in order to receive electromagnetic and/or optical signals from a vehicle environment and/or send electromagnetic and/or optical signals into the vehicle environment. The optical feature can be configured to extend a field of view or an angle of view of the at least one component and/or limit the same to a predetermined detection area. This can be done by means of a lens or a similar optical element, for example. In the simplest case, the optical feature can comprise a window through which the at least one component can look. In such a case, it is preferred for the at least one component and/or a housing in which the at least one component is disposed not to comprise a see-through area so as to ensure that the at least one component looks through a single window or a single see-through area in order to detect the vehicle environment. This allows reducing detection losses that occur when sending and/or receiving electromagnetic signals because of a penetration of the see-through area even though it is transparent to predetermined wavelengths.

A communication interface of this kind can preferably be configured to receive data from outside the motor vehicle and/or send data to a vehicle environment. For example, the communication interface can be configured to communicate with a server or a cloud from which data can be retrieved and/or on or in which data can be stored. For example, the communication interface can be a WLAN interface and/or a radio interface and/or a GPS interface and/or a Bluetooth interface.

An energy generation feature of this kind can be configured to generate the electrical energy required for operating the at least one component or convert it into electrical energy from another form of energy (e.g., solar energy), for example. The energy generation feature can comprise at least one photovoltaic cell, for example, by means of which the solar energy can be converted into electrical energy. The energy generation feature preferably comprises power electronics and/or a DC/DC converter and/or an AC/DC converter. Thus, a required voltage level or power level can preferably be provided in a manner specific to the component. The energy generation feature is preferably disposed in a roof area of the panel component. The energy generation feature can provide energy required for the electrical system of the vehicle and/or for the at least one component with the result that an energy storage (e.g., a traction battery) required for driving the motor vehicle is relieved, leaving the motor vehicle with a greater range, for example.

An energy storage feature of this kind can be a battery and/or a super capacitor, for example. This allows energy generated by the preferred energy generation feature to be temporarily stored in order to supply the at least one component with energy even when the energy generation feature cannot generate energy, for example. In principle, it is also possible that the roof module merely comprises a battery management system and other parts of the energy storage feature, such as the battery cells and/or the super capacitors, are comprised in other areas of the motor vehicle.

Of course, the embodiments and the illustrative examples mentioned above and yet to be discussed below can be realized not only individually but also in any combination with each other without departing from the scope of the present invention. Moreover, any and all embodiments and illustrative examples also relate equivalently or at least similarly to the roof module according to the invention without being mentioned separately in its context.

### BRIEF DESCRIPTIONS OF THE DRAWINGS

Embodiments of the invention are schematically illustrated in the drawings and will be discussed as examples below.

FIG. 1 is a first schematic view of a motor vehicle having a vehicle body and a roof assembly forming a roof module;

FIG. 2 is a second schematic view of a motor vehicle having a vehicle body and an exemplary embodiment of a roof assembly;

FIG. 3 is a schematic view of an exemplary embodiment of a roof assembly;

FIG. 4 is a schematic view of an exemplary embodiment of a roof assembly;

FIG. 5 is a first schematic section view of a roof assembly; and

FIG. 6 is a second schematic section view of a roof assembly.

### DETAILED DESCRIPTION

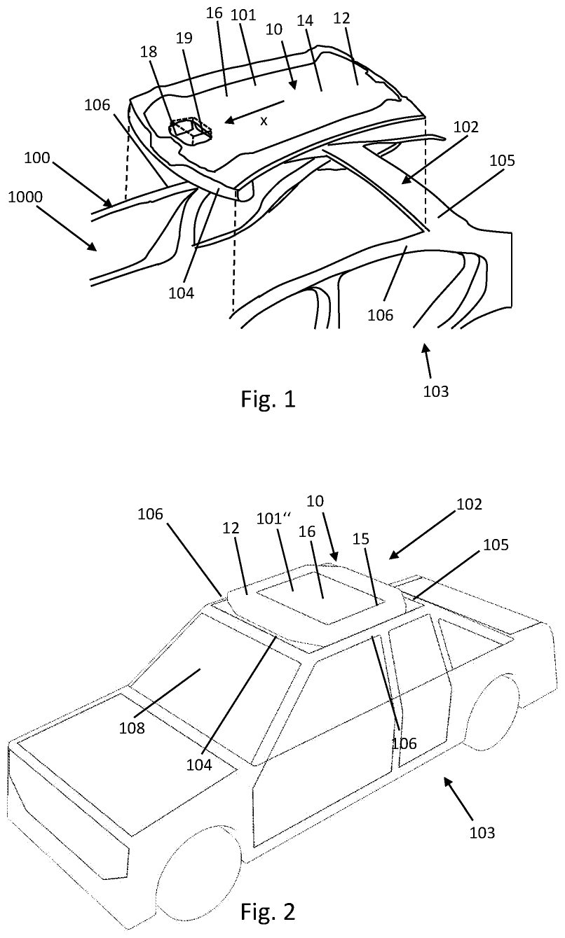

FIG. 1 shows a motor vehicle 1000 having a roof assembly 100. Roof assembly 100 is formed by a roof module 10 in the case at hand. Roof module 10 is disposed on a vehicle roof frame 102 of a vehicle body 103 as a structural unit. Its placement, which takes place from the top in the case at hand, is schematically illustrated in the form of dashed lines. In the case at hand, vehicle roof frame 102 of vehicle body 103 is formed by at least one vehicle body rail 104, which defines a front transverse rail or transverse beam, which forms a roof header of motor vehicle 1000, with respect to longitudinal vehicle direction x. Furthermore, vehicle roof frame 102 comprises a rear transverse rail 105 with respect to longitudinal vehicle direction x and two longitudinal rails 106, which are parallel to each other and longitudinal vehicle direction x and/or mirror-symmetrical to each other. Together, transverse rail 105 and the two longitudinal rails 106 or side rails form vehicle roof frame 102, which has an in particular closed frame structure. In the case at hand, a windshield 108 is disposed on front transverse rail 104.

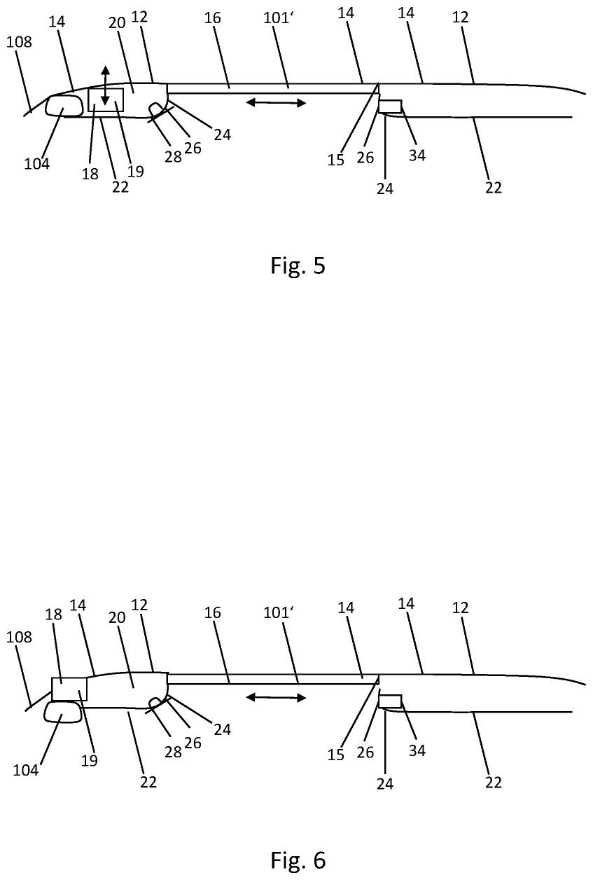

Roof assembly 100 or roof module 10 comprises a panel component 12 for partially forming a roof skin 14 of roof assembly 100. In the case at hand, a roof opening 15 is provided in roof skin 14, roof opening 15 being filled by a roof panel element 16, which is formed by a panoramic roof 101 in the case at hand. In other exemplary embodiments, roof panel element 16 can also be part of a roof opening system configured to selectively open or close roof opening 15. For example, roof panel element 16 can be a sunroof 101′ (see FIG. 5). Alternatively, roof panel element 16 can be a fixed roof element 101″, which fills roof opening 15 (see FIG. 2). Roof panel element 16 forms roof skin 14 together with panel component 12.

According to FIGS. 1 and 5, an electrical and/or electronic and/or electromagnetic component 18, which is an environment sensor 19 in the case at hand, is disposed in an installation space 20 in a front center roof area of roof assembly 100 or roof module 10 with respect to a longitudinal vehicle direction x, installation space 20 being limited by roof skin 14 and a roof headliner 22 (see FIG. 5 in particular). Roof headliner 22 serves as a cover of the roof area inside the vehicle, preventing a passenger from looking into a roof carcass structure. Roof headliner 22 is disposed below and spaced apart from roof skin 14 and/or panel component 12, thus limiting installation space 20 together with the latter. Roof headliner 22 is spaced apart from roof skin 14 since body roof frame 102 is disposed in between, for example. Alternatively or additionally, roof module 10 can of course also comprise a roof module frame (not shown), which allows it to be disposed on body roof frame 102. According to FIGS. 1 and 5, environment sensor 19 is disposed in installation space 20 in such a manner that it can be retracted and deployed, environment sensor 19 being shown in a deployed state in FIG. 1 and in a retracted state in FIG. 5. The adjustability of environment sensor 19 is indicated by a double arrow in FIG. 5. In other exemplary embodiments, environment sensor 19 can also be disposed in a fixed manner in the area of transverse rail 104, for example, and can protrude over roof skin 14 (see FIG. 6). Of course, environment sensor 19 is disposed in a front area of motor vehicle 1000 as an example only. In other embodiments, which are not shown, environment sensor 19 and/or multiple environment sensors 19, of course, can also be disposed in a rear area and/or a lateral area and/or a corner area of the vehicle roof and/or elsewhere on motor vehicle 1000.

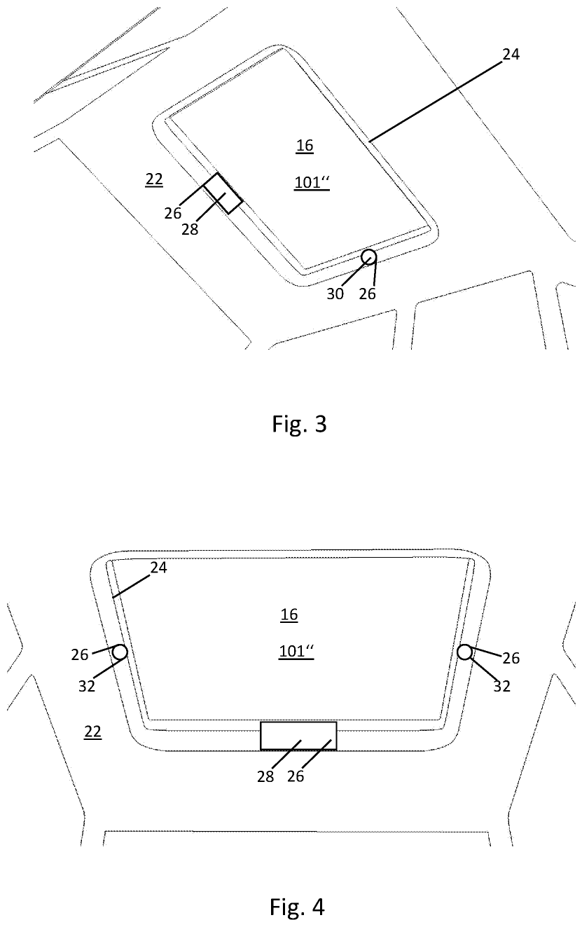

According to the invention, roof headliner 22 comprises a cover element 24, which covers an edge area around roof opening 15 inside the vehicle. Cover element 24 can be disposed on said edge area while being separate from remaining roof headliner 22 (see FIGS. 3 and 4). Cover element 24 and roof headliner 22 can also be formed integrally (see FIGS. 5 and 6).

According to the invention, at least one functional feature 26 is disposed on and/or connected to and/or attached to cover element 24. Cover element 24 forms at least one mounting surface on a surface opposite a vehicle interior, the mounting surface extending along the edge area of roof opening 15, and the at least one functional feature 26 being disposed on the mounting surface. Cover element 24 forms an in particular essentially vertical wall area of installation space 20, to which the at least one functional feature 26 is attached. As shown in FIGS. 3 and 4, cover element 24 is disposed circumferentially around roof opening 15.

In FIGS. 3 to 5, the at least one functional feature 26 comprises an image display feature 28, in particular a display. Furthermore, functional feature 26 comprises an audio playback feature 30, in particular a microphone, according to FIG. 3. According to FIG. 4 functional feature 26 further comprises two sensor-based detection features 32, in particular cameras. According to FIGS. 5 and 6, the at least one functional feature 26 comprises a control element 34.

In the case at hand, environment sensor 19 is a lidar sensor. Other sensor types, such as (multi-directional) cameras and/or ultrasonic sensors, can be employed as well. Environment sensor 19 is configured to send and/or receive electromagnetic signals in order to detect a vehicle environment of motor vehicle 1000 (e.g., for autonomous driving or parking).

1. A roof assembly for a passenger car, the roof assembly comprising:
a roof skin comprising at least one roof opening;
at least one roof panel element configured to selectively open or close the roof opening and/or forming a fixed roof element having an at least partially transparent see-through area and filling the roof opening; and
a roof headliner disposed below and spaced apart from the roof skin, thus limiting an installation space together with the roof skin, and comprising a cover element covering at least part of an edge area around the roof opening inside the vehicle,
wherein at least one functional feature is disposed on the cover element.

2. The roof assembly according to claim 1, wherein the cover element is formed integrally with the roof headliner.

3. The roof assembly according to claim 1, wherein the cover element forms at least one mounting surface on a surface opposite a vehicle interior, the mounting surface extending along the edge area of the roof opening, and the at least one functional feature being disposed on the mounting surface.

4. The roof assembly according to claim 1, wherein the cover element forms an essentially vertical or inclined wall area of the installation space, the at least one functional feature being attached to said wall area.

5. The roof assembly according to claim 1, wherein the at least one functional feature comprises at least one image display feature and/or one audio playback feature and/or one touch panel and/or one control element and/or one light feature and/or one feature for optical communication and/or one sensor-based detection feature.

6. The roof assembly according to claim 1, wherein the roof assembly defines a roof module for forming the vehicle roof, the roof module comprising at least one electrical and/or electronic and/or electromagnetic component, which is configured to send and/or receive electromagnetic signals in order to detect a vehicle environment and which is disposed in the installation space limited by the roof skin and the roof headliner.

7. The roof assembly according to claim 6, wherein the least one electrical and/or electronic and/or electromagnetic component comprises an antenna and/or a measuring sensor and/or a communication feature and/or a light feature.

8. The roof assembly according to claim 6, wherein the environment sensor comprises a lidar sensor and/or a radar sensor and/or a camera sensor and/or a multi-camera sensor and/or an ultrasonic sensor.

9. The roof assembly according to claim 6, wherein the roof module is disposed on a vehicle body of a motor vehicle as a structural unit.

10. The roof assembly according to claim 1, wherein at least one cleaning feature and/or one temperature control feature and/or one control feature and/or one amplifying feature and/or one optical feature and/or one communication interface and/or one energy generation feature and/or one energy storage feature is disposed in the installation space limited by the roof skin and the roof headliner.

11. A motor vehicle comprising a roof assembly according to claim 1.

12. The roof assembly according to claim 6, wherein the at least one electrical and/or electronic and/or electromagnetic component is an environment sensor.
